(19) United States
(12) Patent Application Publication
(10) Pub. No.: US 2019/0234093 A1
(43) Pub. Date: Aug. 1, 2019

(54) TOOL FOR AIDING IN USE OF POOL CLEANING APPARATUSES AND METHOD OF USE

(71) Applicant: Shannon Galway, Fulshear, TX (US)

(72) Inventor: Shannon Galway, Fulshear, TX (US)

(21) Appl. No.: 16/258,648

(22) Filed: Jan. 27, 2019

Related U.S. Application Data
(60) Provisional application No. 62/622,872, filed on Jan. 27, 2018.

(51) Int. Cl. E04H 4/16; F16M 13/02

(52) U.S. Cl. CPC E04H 4/1609; F16M 13/022

(57) ABSTRACT

A tool to affix to a pole of a pool cleaning apparatus to prevent the pool cleaning apparatus from sliding into a pool, the tool includes a cylindrical collar to secure onto the pole; and a flange projecting outwardly from the cylindrical collar; the flange provides a means to catch on a side of the pool to prevent the pool cleaning apparatus from sliding into the pool.

### BACKGROUND

### 1. Field of the Invention

The present invention relates generally to pool cleaning systems, and more specifically, to a tool for use with a pool cleaning apparatus for preventing the apparatus from falling into the pool.

### 2. Description of Related Art

Pool cleaning systems are well known in the art and are effective means to remove dirt and debris from a pool. For example, FIG. 1 depicts a conventional pool cleaning system 101 having a cleaning apparatus 103 with a pole 105 extending an apparatus head 107, such as a vacuum or broom, into a pool 109. During use, the user proceeds to use apparatus 103. The user commonly rests pole 105 on a side 111 of the pool unattended, wherein the apparatus will begin to slide into the pool, as shown with arrow A.

One of the problems commonly associated with system 101 is the slipping of apparatus 103 into the pool, which causes problems for the user to retrieve.

Accordingly, although great strides have been made in the area of pool cleaning systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified perspective view of a common pool cleaning system;

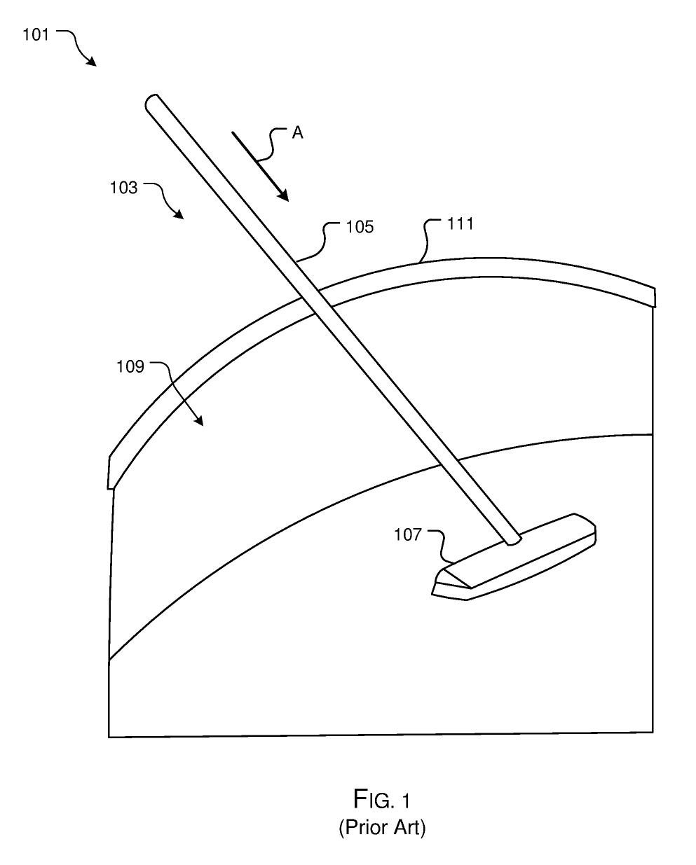

FIG. 2 is a simplified perspective view of a pool cleaning system in accordance with a preferred embodiment of the present application;

FIG. 3 is an oblique view of a tool from FIG. 2; and

FIG. 4 is a flowchart of the method of use of the system of FIG. 2.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional pool cleaning systems. Specifically, the present invention provides a means to prevent a pool cleaning apparatus from falling into the pool when not held by the user. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

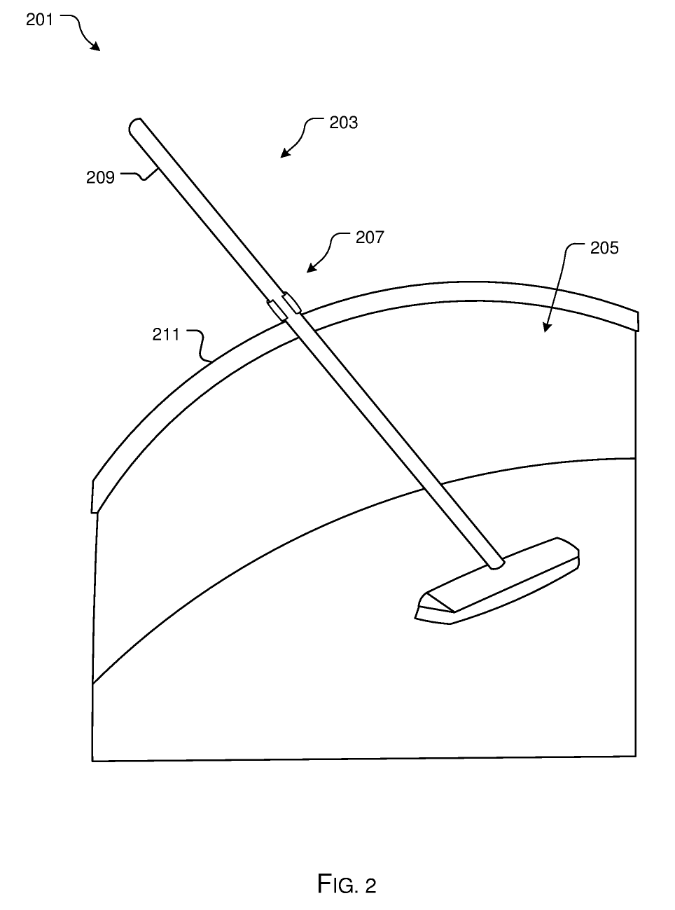

Referring now to the drawings wherein like reference characters identify corresponding or similar elements throughout the several views, FIG. 2 depicts a simplified perspective view of a pool cleaning system 201 in accordance with a preferred embodiment of the present application. It will be appreciated that system 201 overcomes one or more of the above-listed problems commonly associated with conventional pool cleaning systems.

In the contemplated embodiment, system 201 includes a pool cleaning apparatus 203, such as a broom device, a vacuum device, a scrubbing device, or the like configured to be used to clean a pool 205. System 201 further includes a tool 207 configured to snap, or otherwise secure onto a pole 209 of apparatus 203, the tool 207 providing a flange 301 to catch on a side 211 of pool 205. It should be appreciated that tool 207 thereby prevents apparatus 203 from sliding into pool 205. It must be understood that the tool 207 can snap, bolt, clamp, slide onto, or otherwise secure to pole 209.

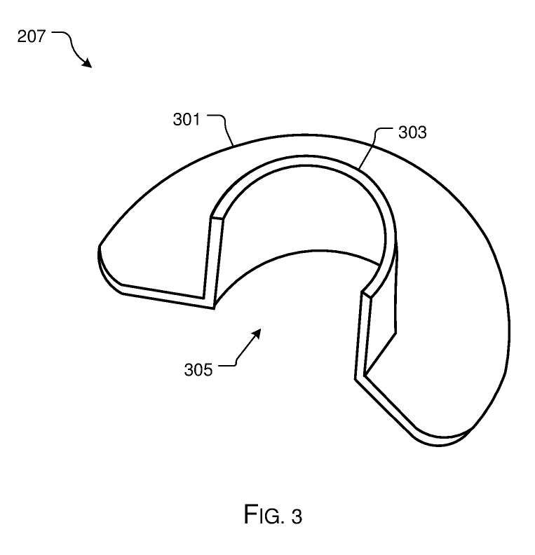

In FIG. 3, an oblique view of one embodiment of a tool 207 is shown. Tool 207 includes a partially cylindrical collar 303 with an opening 305, thereby allowing for the tool 207 to snap, or otherwise secure around the pole of the cleaning apparatus. Tool 207 further having flange 301 extending away from collar 303, flange 301 providing the means to catch on the side of the pool.

In an alternative embodiment, tool 207 is integrally incorporated into the pole 209, thereby being unremovable and providing an apparatus for cleaning a pool, with the functionality of tool 207 built in.

It should be appreciated that one of the unique features believed characteristic of the present application is tool 207, which provides an easy means to attach the tool to a pole to prevent a cleaning apparatus from sliding into the pool. It should be appreciated that the size of tool 207 can vary, however, one contemplated size includes an approximate diameter of 1.2 inches associated with the collar, and an approximate diameter of 3.0 inches associated with the outer flange, each having a thickness of approximately ⅛ inch.

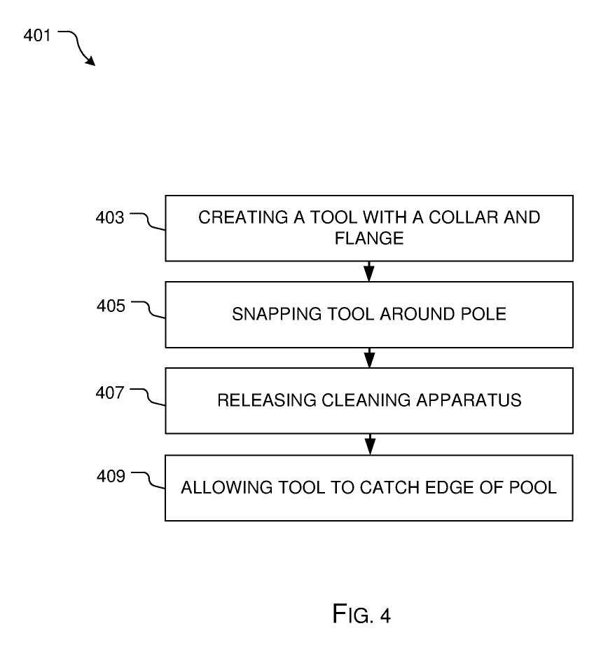

In FIG. 4, a flowchart 401 depicts a method of use associated with system 201. During use, the tool with a collar and flange is created, wherein the collar allows for snapping, or otherwise securing, the tool around a pole associated with a pool cleaning apparatus, as shown with boxes 403, 405. As the user cleans a pool, the user can rest the pole on the edge of the pool unattended, wherein the tool prevents the apparatus from falling into the pool, as shown with boxes 407, 409.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A tool configured to affix to a pole of a pool cleaning apparatus to prevent the pool cleaning apparatus from sliding into a pool, the tool comprising:
a partial cylindrical collar configured to secure onto the pole; and
a flange projecting outwardly from the partial cylindrical collar;
wherein the flange provides a means to catch on a side of the pool to prevent the pool cleaning apparatus from sliding into the pool.

2. A pool cleaning system, comprising:
a pool cleaning apparatus having a pole configured to extend a cleaning device into the pool; and
a tool configured to affix to the pole, the tool having:
a partial cylindrical collar configured to secure onto the pole; and
a flange projecting outwardly from the partial cylindrical collar;
wherein the flange provides a means to catch on a side of the pool to prevent the pool cleaning apparatus from sliding into the pool.

3. A method of preventing a pool cleaning apparatus from sliding into a pool, the method comprising:
creating a tool having a partial cylindrical collar and a flange protecting away from the partial cylindrical collar;
securing the tool around a pole of the pool cleaning apparatus at a desired location;
using the pool cleaning apparatus as desired; and
leaving the pool cleaning apparatus unattended;
wherein the flange of the tool catches on a side of the pool to prevent the pool cleaning apparatus from sliding into the pool.
